(19) United States
(12) Patent Application Publication
(10) Pub. No.: US 2016/0144463 A1
(43) Pub. Date: May 26, 2016

(54) FILLER FOR THE WELDING OF MATERIALS FOR HIGH-TEMPERATURE APPLICATIONS

(71) Applicant: SANDVIK INTELECTUAL PROPERTY AB, Sandviken (SE)

(72) Inventors: Joel HELLSTEN, Vasteras (SE); Susanne HELLSTROM SELIN, Vasteras (SE); Thomas HELANDER, Vasteras (SE)

(21) Appl. No.: 14/899,188

(22) PCT Filed: Jun. 17, 2014
(86) PCT No.: PCT/SE2014/050732

§ 371 Date: Dec. 17, 2015

(30) Foreign Application Priority Data
Jun. 18, 2013 (SE) 1350744-7

(51) Int. Cl. B23K 35/30; C22C 38/50; C22C 38/00; C22C 38/04; C22C 38/02; C22C 38/58; C22C 38/06

(52) U.S. Cl. CPC B23K 35/3086; C22C 38/58; C22C 38/50; C22C 38/06; C22C 38/04; C22C 38/02; C22C 38/004; C22C 38/001

(57) ABSTRACT

A filler for welding including (in % by weight):
C: ≦0.036
Ni: 15.0-20.0
Cr: 15.0-22.0
Mn: 0.75-2.0
Zr: 0.1-1.45
Si: 0-1.5
Al: 0-2
N: <0.06
   and a balance of Fe and inevitable impurities.

### TECHNICAL FIELD

The invention concerns a filler for welding according to the preamble of claim 1.

### BACKGROUND ART

In many industrial processes, there are high temperatures and adverse atmospheres, which makes that the material of the equipment may oxidize or corrode rapidly and/or creep so that the material gets an unacceptable change of geometry. Examples of such processes are thermal cracking for creating ethylene for plastics manufacturing wherein high pressure and high temperatures are used. The furnace tubes may then have a surface temperature of up to 1050° C. This makes great demands on corrosion resistance and high-temperature strength. Other high-temperature applications are furnace rolls in, for example, hardening furnaces and radiant tubes for heating elements. In all these cases, it is aimed to increase the service life of the material in order to decrease the number of maintenance shutdowns and expensive repairs. It is also an aim to raise the temperature in order to increase productivity.

A material for high-temperature applications is ferritic iron-chromium-aluminium (FeCrAl) alloys, which have considerably better properties than austenitic iron-nickel-chromium (FeNiCr) alloys. Thanks to the good oxidation and corrosion properties of the ferritic FeCrAl alloys, they are commonly used for resistive heating wire. By a powder process, it is possible to produce tubes from FeCrAl alloys and get high strength at high temperatures. Therefore, ferritic FeCrAl alloys can be used also for radiant tubes, furnace rolls, structural components of furnaces such as fixtures, supports, nozzles for burners, etc.

In many cases when ferritic FeCrAl alloys are used as construction material, it has to be joined to some other high-temperature material, often an austenitic stainless steel. Using screw joints may be a solution in certain cases, but no type of joint becomes as strong as a correctly made welding. Furthermore, a weld becomes gas-tight, in contrast to a normal screw joint. As for the welding of ferritic FeCrAl alloys to austenitic stainless steel, there are however challenges in the materials chemistry to get to a strong welding seam.

A ferritic FeCrAl alloy is Kanthal APMT and is a further development of earlier ferritic FeCrAl alloys. APMT is powder made and has excellent oxidation and corrosion properties as well as good form stability thanks to high creep resistance. In many cases, it is desired to use APMT only in the position that is most exposed to high temperatures, while other parts are rather made from austenitic high-temperature materials. A welding between the different materials is required, but it cannot be made that easily.

The alloying materials of the parent metals and of the fillers have great impact on the mechanical properties of the welding seam. In previous studies, it has been observed that several intermetallic phases have been formed upon welding of APMT material to stainless austenitic steel, which cause problems.

The stainless austenitic steels are alloyed with nickel. Furthermore, nitrogen can be added in order to stabilize the austenitic phase. These elements diffuse from the parent metals into the filler and there form hard and brittle intermetallic phases, which impair the mechanical properties of the welding seam.

Aluminium nitride, AlN, is a hard and brittle phase that is very stable. Not until temperatures above about 1800° C. are reached, it is dissolved.

Nickel aluminides exist in two variants, namely NiAl and Ni₃Al. Ni₃Al, which also is called γ, is a brittle phase. Upon a quantity ratio of 13% by weight of Al and 87% by weight of Ni, Ni₃Al is stable all the way up to 1395° C., NiAl is stable all the way up to 1638° C. when it is 68% by weight of Ni.

σ-phase is an undesirable phase, which already at small amounts, about 1% of the material, makes the welding seam brittle. The σ-phase grows in the grain boundaries and the phase is stabilized by Cr, Mo, and Si. σ-phase is formed in the temperature range of 550-800° C. The fact that Cr is depleted in the vicinity of σ-phase at the grain boundaries makes the material becoming weaker against intercrystalline corrosion.

Laves phases arise at lower temperatures than 750° C. and are brittle. Laves phases are rich in Mo, and therefore APMT, which contains 3% by weight of Mo, can be affected by laves phases.

Another problem that arises in the weld, upon welding with conventional fillers, is pores. They are believed to arise due to the Kirkendall effect, which is that a net diffusion of certain atoms in one direction makes that the atoms leave voids behind them. There are not sufficiently many other atoms diffusing in the opposite direction to fill up the vacancies that arise. The longer time in high temperature, the more pores arise. Above all, the diffusion of Al from APMT to the stainless austenitic steel is believed to be the major cause of the pores.

Within prior art, different fillers for welding have been proposed.

JPS6313692A discloses a filler for the welding of austenitic stainless steel in nuclear reactors. SU1618553 discloses a filler for welding that is alloyed with titanium or niobium with the purpose of forming titanium or niobium carbides in the filler. Another filler for welding is disclosed in JPS551909.

The object of the invention is to provide a filler for welding in which at least one of the above problems is solved or avoided. In particular, the filler should be suitable for the joining of austenitic stainless steel with ferritic FeCrAl alloys in constructions used at high temperatures, i.e., 750° C. or higher. More specifically, it is an object of the present invention to provide a filler for welding wherein the effect of the initially mentioned brittle phases is avoided or at least minimized upon joining austenitic stainless steel with ferritic FeCrAl alloys.

### SUMMARY OF THE INVENTION

According to the invention, at least one of the above objects is achieved by a filler for welding comprising (in % by weight):
C: ≦0.036
Ni: 15.0-20.0
Cr: 15.0-22.0
Mn: 0.75-2.0
Zr: 0.1-1.45
Si: 0-1.5
Al: 0-2
N: <0.06
balance Fe and inevitable impurities.

Experiments have been made wherein the filler according to the invention has been utilized to, by means of TIG welding, join a workpiece of Fe—Cr—Al (APMT) high-temperature steel to a workpiece of austenitic stainless steel. The experiments surprisingly showed that the resulting welding seam obtained very good mechanical properties in respect of tensile testing and creep resistance as well as good oxidation resistance at high temperatures.

The zirconium filler in the filler according to the invention results in the presence of aluminium nitrides (AlN) as well as nickel aluminide (NiₓAlₓ) in the resulting welded joint being minimized and eliminated, respectively, which has positive impact on the mechanical properties of the welded joint. The lack and low presence, respectively, of AlN and NiₓAlₓ in the welding seam is assumed to depend on the filler of zirconium reacting with nitrogen from the workpiece and forming ZrN, which prevents the formation of AlN as well as brittle intermetallic phases, such as nickel aluminide (NiₓAlₓ).

The good corrosion resistance is assumed to depend on the relatively high content of nickel, above 12% by weight.

According to an alternative, C is: 0.030 or 0.020% by weight.

According to an alternative, Ni is: 15-17 or 17-20% by weight.

According to an alternative, Cr is: 17-19 or 17-22 or 15-19% by weight.

According to an alternative, Mn is: 0.75-1.75% by weight.

According to an alternative, Zr is: 0.35-1.45 or 1.15-1.45 or 0.35-1.39 or 0.1-1.3 or 0.35-0.65 or 0.5-0.7% by weight.

According to an alternative, Si is: 0.3-1% by weight.

According to an alternative, Al is: 0-1, preferably 0.3-1% by weight.

According to an alternative, N is: 0-0.03, preferably 0% by weight.

The filler may, for example, be provided in the form of welding band or welding wire.

C: Carbon has strong affinity to zirconium. In the filler according to the invention, it is important that zirconium is present freely so as to be able to bind nitrogen that diffuses from the parent metal into the welding seam. In order to avoid that zirconium in the filler is bound by carbon, according to the invention, the content of carbon in the filler should be as low as possible, preferably ≦0.036% by weight, more preferred ≦0.030% by weight, more preferred 0.020% by weight.

Ni: Nickel improves high-temperature strength as well as oxidation resistance at high temperatures. However, at too high contents, nickel aluminide with aluminium from the APMT material is formed. The nickel aluminide may cause cracks and depletes the APMT material of aluminium, thereby impairing its properties in respect of oxidation and corrosion resistance. Experiments, which have been made with the filler according to the invention, show that a content of nickel of 15-20% by weight provides a very good oxidation protection in the welded joint at temperatures above 750° C. Preferably, nickel is included in an amount of 15.0-17.0% by weight or 17.0-20.0% by weight.

Cr: Chromium improves weldability and fluidity and should therefore be included in an amount of at least 17.0% by weight. High contents of chromium may lead to the formation of chromium carbides, which make the welding seam brittle. Chromium should therefore be included in amounts of at most 22.0% by weight. Preferably, the content of chromium is 17.0-19.0% by weight.

Mn: Manganese is a good austenite former and may therefore, to a certain extent, replace nickel. Furthermore, manganese has positive impact on the hot ductility of the welding seam as well as provides good welding characteristics. Manganese should therefore be included in an amount of at least 0.75% by weight. However, manganese increases the solubility of nitrogen as well as impairs the oxidation properties of the welding seam and should therefore be limited to at most 2.0% by weight.

Si: Silicon may be included in the filler, since it has a positive impact on the fluidity.

Al: Aluminium has a positive impact on the oxidation resistance and may therefore be included the filler. However, high contents of aluminium may cause brittle AlN inclusions.

The content of Al should therefore be at most 2% by weight, preferably at most 1% by weight, more preferred 0.3-1% by weight.

N: Most preferably, nitrogen should not be present at all in the filler, since it gives rise to brittle phases. Therefore, nitrogen should most preferably be 0% by weight in the filler. Small amounts in the form of impurities may, however, be allowed in contents up to 0.06% by weight, preferably 0.03% by weight.

Zr: According to the invention, zirconium is included in the filler. This element has a high affinity to nitrogen and therefore forms ZrN with the nitrogen that diffuses from the austenitic workpiece to the filler. The lower limit is set to guarantee a sufficient amount of Zr to bind nitrogen. The higher level is set because high contents of Zr may lead to grain-coarsening, which has a negative impact on the mechanical properties of the welding seam at room temperature.

The balance of the filler up to 100% by weight consists of iron (Fe) as well as inevitable impurities.

### DESCRIPTION OF DRAWINGS

FIGS. 1-6: SEM images of welded joints produced from the filler according to the invention.

FIG. 7: Drawing of test bar used in the experiments.

FIG. 8: Tabulation of chemical composition of the fillers according to the invention used in the experiment.

FIG. 9: Chemical composition of parent metal APMT, Incoloy800HT as well as 253 Ma.

### DEFINITIONS

In the present application, with “filler”, reference is made to the material that upon joining two or more workpieces forms the welding seam between the workpieces.

With “parent metal” or “workpiece”, in the present application, reference is made to the materials that are joined with “the filler”.

### EXAMPLES

In the following, the welding material according to the invention will be described with reference to concrete experiments. Before the experiments, first the parent metals were determined. These became APMT, Incoloy 800HT, and 253 MA. Chemical analysis of the parent metals used in the experiments is seen in FIG. 9.

In order to get a sufficient amount of material for making tensile test pieces and creep test pieces, it was determined that the parent metals should be in the form of tubes in lengths of 15 cm having an outer diameter YD of 88.9 mm and a wall thickness of 5.0 mm. The parent metals are commercially available.

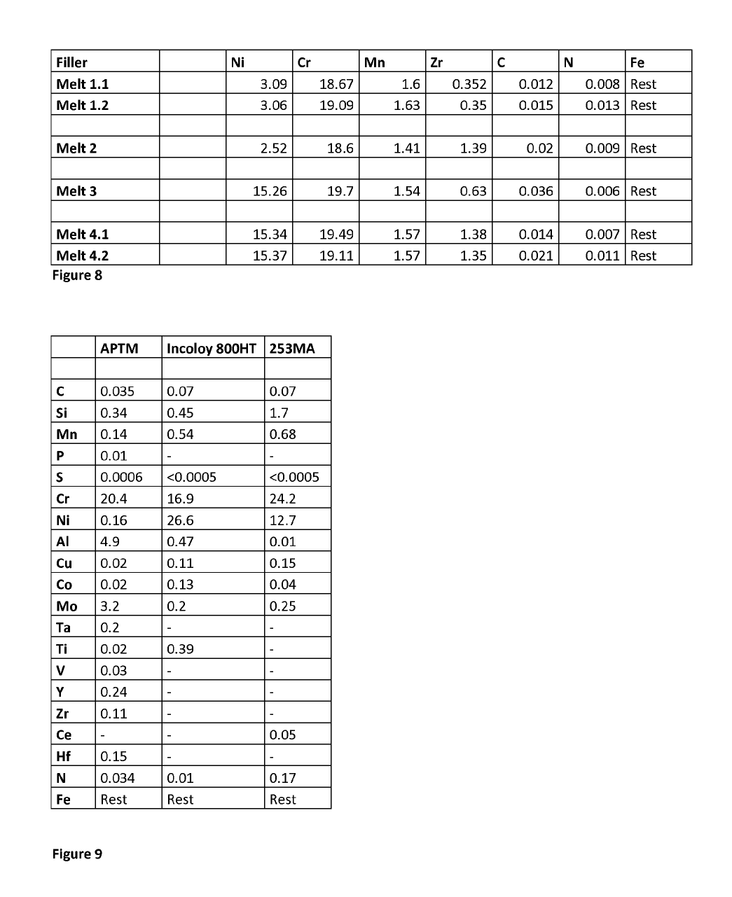

Next, the fillers were produced. A tabulation of all melting experiments and their composition is seen in FIG. 8. The melts were produced in the following way:

First, the incorporated alloying materials were weighed. Each metal was weighed on a balance of the make Sartorius BP 41005. The accuracy of the weighing was ±0.3 g. The total weight of each experimental melt was 1100 g.

Melting was effected inductively in a furnace of the make Balzers. First, the container, in which the crucible is situated, was pumped down to a pressure of 0.1 torr. Then, a preheating of the crucible and the alloying materials was made. Before the melting was initiated, the container was filled with the protective gas Ar to a pressure of 400 torr. In the end of the melting, a part of Zr was added to the melt via a lance in the lid of the container. This procedure is called spiking and is made because Zr has a very high reactivity with oxygen. Although it is a deliberately low partial pressure of O in the container, Zr reacts rapidly with the small amount of O present and disappears from the usable part of the melt.

For every melting experiment, chemical analysis was made to check the actual composition in finished ingot. Two melts of No. 1 and No. 4 were needed to get a sufficient amount of welding wire for welding APMT to 253 MA also.

After casting, the ingot was turned into cylindrical blanks, which were hot-rolled into a diameter of 6 mm. Then, they were drawn into a diameter of 1.6 mm. The two last steps were made for only a seventh part of the wires.

Next, the wires were used to weld together tubes of APMT to Incoloy 800HT and APMT to 253 MA by means of TIG welding. Before welding, the tubes were cleaned and pickled.

Root gas was used to protect the root bead from oxidizing and forming slag. To get to an effective root gas protection, end portions for the tubes were needed. All tubes were edge prepared in both ends for providing a second chance should the first welding attempt fail. Therefore, end portions were needed having a diameter corresponding to the new inner diameter of the tubes plus two times the thickness of the lip in the single U groove. The result was a diameter of 82 mm of the end portions. The material of the end portions was plain carbon steel and a thickness of 2 mm was enough. In the middle of the end portions, there should be a hole having a diameter of 7 mm to introduce/discharge the protective gas. On the inlet side, a tube was welded over the hole as an adapter to the protective gas hose.

The tubes were prepared before the welding by attaching the tube end portions by spot-welding and by attaching each material pair by spot-welding. Upon spotting, the tungsten electrode is used to melt together the parent metals. Then, the tubes were put in a furnace for preheating to 300° C. The welding was made with seven beads. For the root bead, a welding current of 80 A was used, and for the rest of the beads, a welding current of 100 A. For the root bead, the welding rod with Ø 1.6 mm was used, and for the rest of the beads, the welding rod with Ø 2.0 mm. In the welding, the voltage was approximately 11 V and the positioner had a constant advancing speed of 100 mm/min. This gave a heat input of about 0.5 kJ/mm for the root bead and about 0.65 kJ/mm for the rest of the beads. The protective gas was pure Ar both in the welding gun and the root protection. The gas flow was 10 l/min in the welding gun and 8 l/min for the root gas.

After welding, the tubes were heated in a furnace at 850° C. for 30 min and then they were allowed to cool down slowly to room temperature.

EDS Analysis of Material Composition in Welding Seam

After the welding, before heat treatment, EDS analysis of the welding seams was made with the purpose of determining their chemical composition. The EDS analysis was made of a sample sized 600 μm times 400 μm, which was taken from the middle of each welding seam. Table 1 shows the result from EDS analysis of the different combinations of materials.

TABLE 1
Result from EDS analysis

| | (Weight %) | | | | | | |
|---|---|---|---|---|---|---|---|
| Weld joint | Ni | Cr | Al | Si | Mn | Zr | Fe |
| APMT-Nr.1-800HT | 9.6 | 20.7 | 0.9 | 0.5 | 1.0 | 0.5 | rest |
| APMT-Nr.2-800HT | 8.1 | 20.5 | 1.0 | — | 1.2 | 1.2 | rest |
| APMT-Nr.3-800HT | 17.2 | 20.6 | 0.8 | 0.5 | 1.4 | 0.4 | rest |
| APMT-Nr.4-800HT | 16.0 | 20.4 | 0.5 | 0.3 | 1.7 | 1.0 | rest |
| APMT-Nr.1-253MA | 4.2 | 20.5 | 0.8 | 0.6 | 1.4 | 0.3 | rest |
| APMT-Nr.4-253MA | 11.3 | 20.9 | 0.8 | 0.7 | 1.3 | 1.1 | rest |

Tensile and Creep Testing

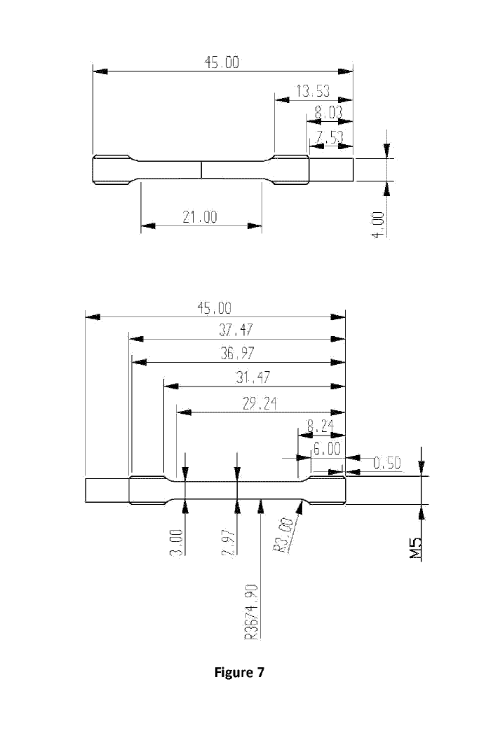

Before the tensile and creep testing, test bars were produced by cylindrical blanks being sawn out from the welded blanks. The cylinders were 100 mm long with the welding seam in the middle. Then, the cylinders were machined into test bars with dimensions according to FIG. 7.

The tensile testing was made with a machine of the make Zwick/Roell Z100. The APMT ends of each test bar were always mounted in the lower drawing jaw. All tensile testing was carried out at room temperature. The creep test pieces were applied in rigs, and beforehand, the diameter of each test bar had been measured with an accuracy of thousands of millimetres.

Tensile Testing

Tensile testing was made both with tensile test pieces, which had been manufactured by turning after welding, and tensile test pieces, which had become heat-treated before tensile testing. The heat treatment went on for 500 h at 750° C.

Table 2 shows ultimate tensile strength and elongation values for the different combinations of materials after heat treatment 500 h at 750° C. Three tensile tests were carried out for each material combination.

TABLE 2
Ultimate tensile strength and elogation values for the different
combinations of materials after heat treatment 500 h at 750° C.

| | | | Rupture |
|---|---|---|---|
| | | Rm | elongation |
| Material combination | Bar no. | [Mpa] | [%] |
| APMT-Nr.1-800HT | 1 | 568 | 20.67 |
| | 2 | 531 | 17.40 |
| | 3 | 570 | 10.82 |
| APMT-Nr.2-800HT | 1 | 587 | 12.48 |
| | 2 | 629 | 6.7 |
| | 3 | 596 | 17.11 |
| APMT-Nr.3-800HT | 1 | 468 | 13.75 |
| | 2 | 401 | 8.98 |
| | 3 | 445 | 10.45 |
| APMT-Nr.4-800HT | 1 | 559 | 17.37 |
| | 2 | 540 | 8.44 |
| | 3 | 380 | 4.44 |
| APMT-Nr.1-253MA | 1 | 710 | 23.02 |
| | 2 | 651 | 8.93 |
| | 3 | 659 | 12.01 |
| APMT-Nr.4-253MA | 1 | 508 | 3.16 |
| | 2 | 618 | 14.77 |
| | 3 | 585 | 14.67 |

From table 2, it is seen that the welding material according to the invention has sufficient strength to be used in welded joints. The strength of a welded construction of different materials is generally set by the strength of the weakest material. Incoloy 800HT has a specified tensile strength of 536 MPa at room temperature (Special Metals datasheet, P. No. SMC-047, Copyright © Special Metals Corporation, 2004 Sep. 4). Thus, it is seen that Fillers 1, 2, and 4 have higher and essentially higher, respectively, strength than the parent metal Incoloy 800HT. The strength of Filler 3 is lower than the strength of Incoloy 800HT. However, Filler 3 is sufficiently strong to be used in welded joints.

The parent metal 253 MA has a tensile strength of 650-850 MPa. In table 2, it is seen that the strength of Filler 1 corresponds to the strength of 253 MA. Filler 4 has sufficiently high strength in comparison with 253 Ma to be usable in welded joints.

Rupture elongation is a measure of the ductility of the weld metal. The rupture elongation in table 2 exceeding 8% are considered be sufficient for the weld or welding seam to be usable. From table 2, it is seen that the rupture elongation of the inventive materials 1-4 is sufficiently ductile.

Test bar No. 2 of APMT-No. 2-800HT had several pores, which is the explanation why this test bar got so low values.

Creep Testing

Creep testing was carried out at 800° C. with a tensile stress of 28 MPa. Table 3 shows the results from creep testing at 800° C. All samples were subjected to a tensile stress of 28 MPa.

TABLE 3
Creep testing at 800° C.

| | | Time to | | Rupture |
|---|---|---|---|---|
| | Test | rupture | Creep vel. | elongation |
| Material combination | position | [h] | [1/s] | [%] |
| APMT-Nr.1-800HT | C306-1 | 150.0 | 2.22*10⁻⁸ | 2.8 |
| APMT-Nr.2-800HT | C307-2 | 23.5 | 1.58*10⁻⁷ | 7.79 |
| APMT-Nr.3-800HT | C308-3 | 174.0 | 1.65*10⁻⁸ | 2.43 |
| APMT-Nr.4-800HT | C309-4 | 273.0 | 8.07*10⁻⁹ | 4.33 |
| APMT-Nr.1-253MA | C310-5 | 7.5 | 1.51*10⁻⁶ | 18.89 |
| APMT-Nr.4-253MA | D087 | 267.0 | 1.26*10⁻⁸ | 4.7 |

The creep strength of the inventive samples can be compared with the creep strength of APMT, which at 800° C. and 28.8 MPa is 100 h to failure.

From table 3, it is seen that Fillers 1, 3, and 4 exceed the value of APMT. In particular, Filler 4 shows excellent creep resistance, both in combination with Incoloy 800HT and 253 MA.

The low creep values of Filler No. 2 in combination with Incoloy 800HT and Filler 1 in combination with 253 MA are assumed to depend on the presence of much ferrite in the welding seam. The formation of ferrite may in turn depend on the relatively low amount of nickel in the filler.

Study of Oxide Growth after 500 h of Heat Treatment at 1050° C.

An examination was made of the oxide formation on samples having been heat treated for 500 h at 1050° C. The following material combinations were studied: APMT-No. 1-Incoloy 800HT, APMT-No. 2-Incoloy 800HT, APMT-No. 1-253 MA, and APMT-No. 4-253 MA. The oxide formation on the respective sample was estimated ocularly by an experienced laborant.

The result indicated a strong oxide growth on the combinations of materials APMT-No. 1-Incoloy 800HT, APMT-No. 2-Incoloy 800HT, and APMT-No. 1-253 MA. The strong oxide growth on these samples may be assumed to be connected to the low content of Ni in these fillers, which only was 3.09 and 2.52% by weight, which should be compared with 15.26 and 15.37% by weight in Fillers 3 and 4. From table 1, which shows the content of nickel from EDS analysis, it is seen that the content of Ni is approximately 9% by weight in the welding seams with the combinations of materials APMT-No. 1-Incoloy 800HT and APMT-No. 2-Incoloy 800HT. There is apparently too a low content upon use at 1050° C. APMT-No. 1-253 MA has even as low a content of Ni as 4% by weight.

The weld metal in the material combination APMT-No. 4-253 MA has 11% by weight of Ni and has not been affected by corrosion. It is reasonable to assume that the lower limit for how much Ni that is needed for devastating corrosion in the joints not to arise is 10% by weight.

Microscopy

Finally, the microstructure of the welding seams was evaluated by optical microscope and SEM. Before microscopy, the welding seam was cut out into a 25 mm long piece, was encased in 30 mm Bakelite pellet, and was ground and polished. Microscopy was made on samples taken directly after welding as well as on samples, which were heat-treated for 500 h at 750° C.

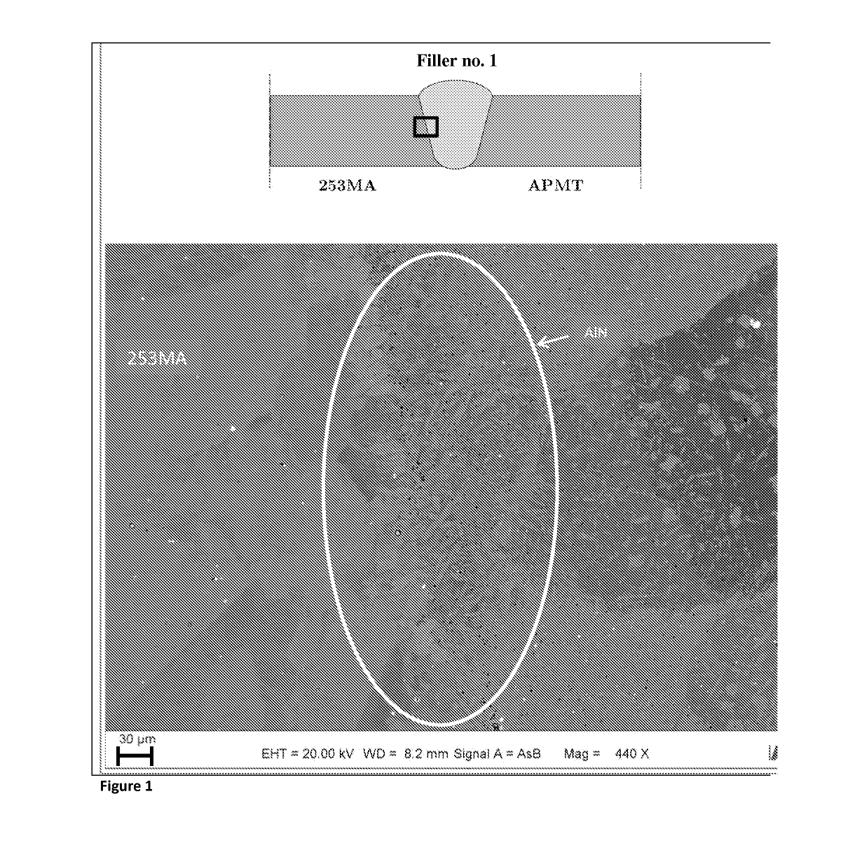

FIG. 1 shows a SEM image in 440 times magnification of a sample from a welded joint between 253 MA-Filler No. 1-APMT taken in the interface between the weld metal and parent metal 253 MA. The sample has been taken directly after welding without heat treatment. The position of the sample is seen in FIG. 1. In the image, small AlN precipitations in the form of about 2 μm large black dots can be observed in the interface between parent metal and the weld metal, see the encircled area in FIG. 1. The weld metal also contains small round white precipitations. By means of SEM, it could be established that these precipitations have a high content of Zr and nitrogen and hence it may be assumed that the same consist of ZrN.

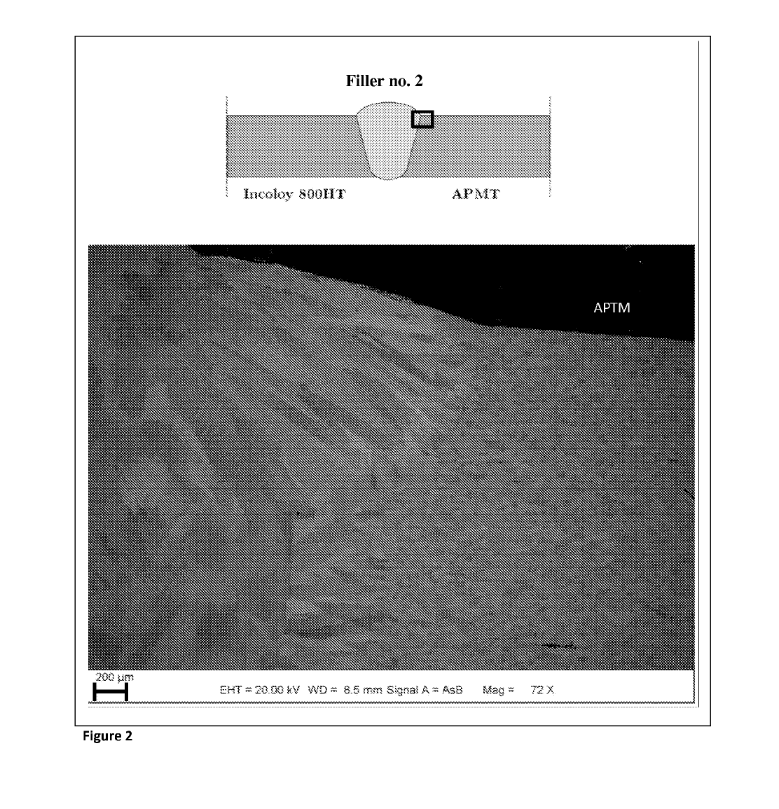

FIG. 2 shows a SEM image from a sample from a welded joint between Incoloy 800HT-Filler No. 2-APMT. The sample has been taken in the interface of weld metal of Filler 2 and the parent metal APMT directly after welding without heat treatment. In this sample, no AlN precipitations could be found. However, in the image, small white precipitations appear, which are evenly distributed across the weld metal. Analysis in SEM shows that these precipitations consist of a NiₓZrₓ phase. Since the content of nitrogen is low in the parent metal both in APMT and Incoloy 800HT, nickel and zirconium form precipitations of NiₓZrₓ instead of AlN. In the finished welding seam, NiₓZrₓ will constitute a reservoir of zirconium. This zirconium will take care of nitrogen that diffuses into the welding seam from the atmosphere in use of the welded joint at high temperatures, thereby preventing and minimizing, respectively, the formation of brittle AlN precipitations.

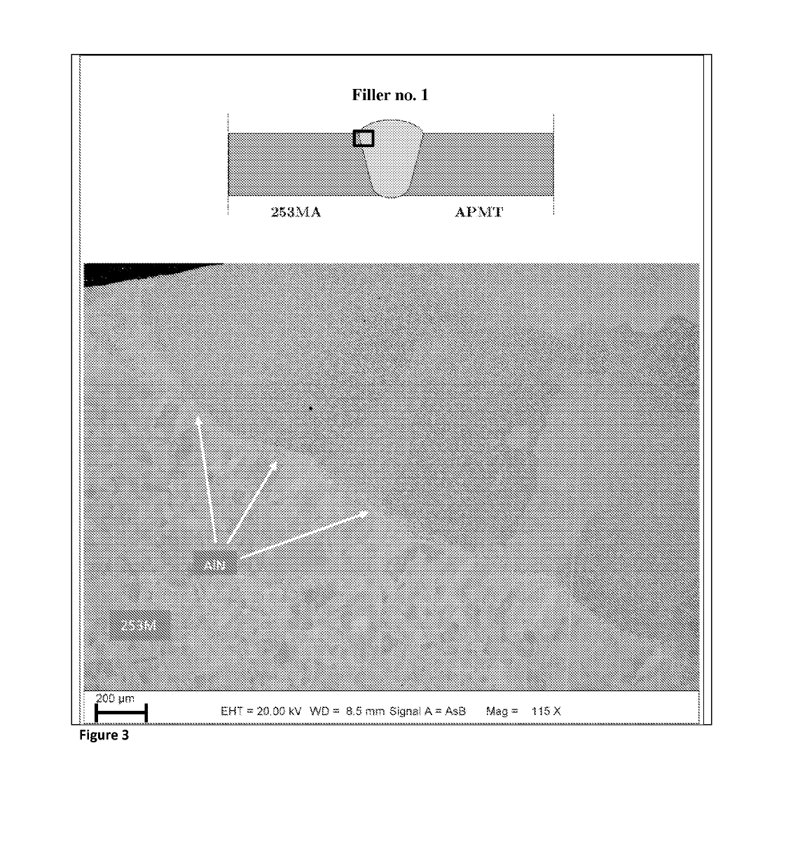

FIG. 3 is a SEM image of a sample taken from the interface between weld metal of Filler 1 and the parent metal 253 MA, which has been heat treated for 500 h at 750° C. Also this sample shows small precipitations of AlN in the interface between weld metal and filler.

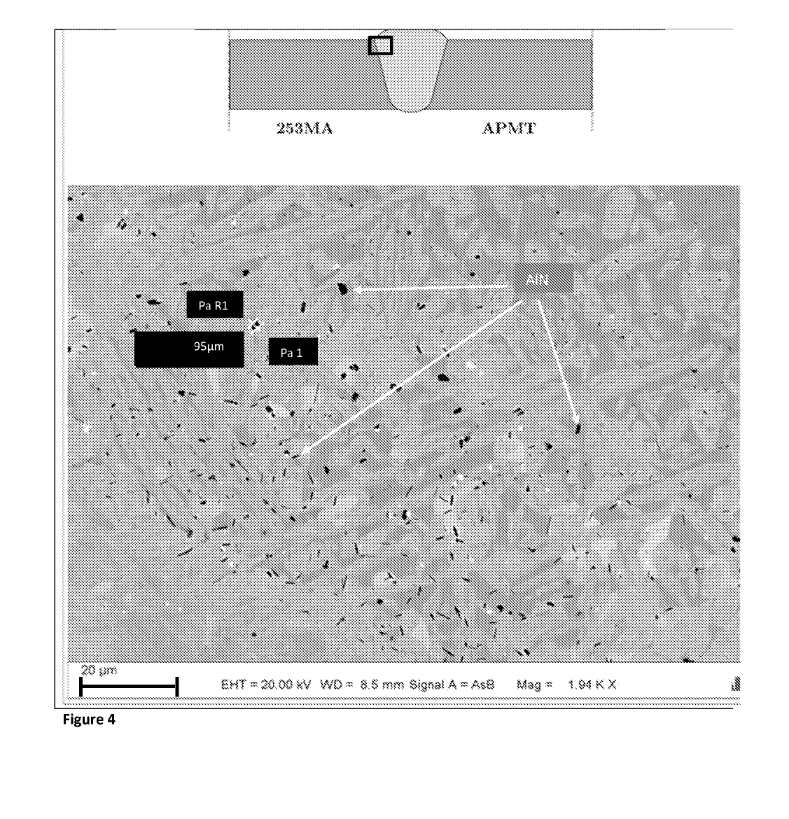

FIG. 4 is a magnification of the weld junction in FIG. 3. In FIG. 3, it is seen that, in addition to AlN, also small white precipitations have been formed, which are assumed to consist to of ZrN.

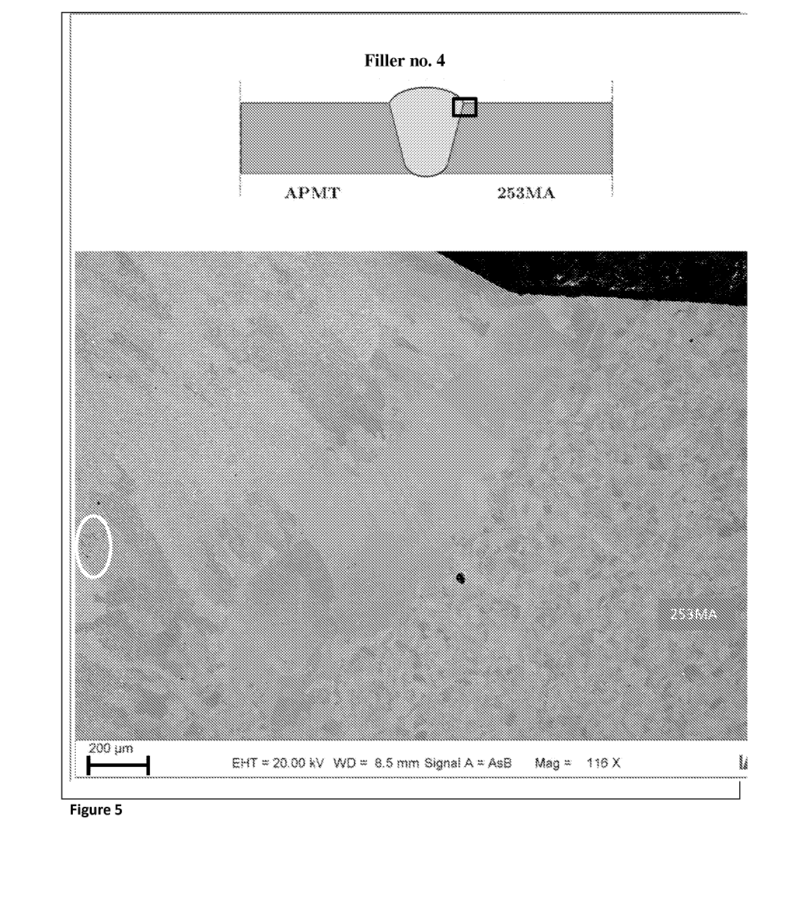

FIG. 5 is a SEM image of a sample taken from the interface between weld metal of Filler 4 and the parent metal 253 MA, which has been heat treated for 500 h at 750° C. In this figure, no AlN precipitations can be observed in the interface between weld metal and parent metal. However, a relatively great amount of white precipitations in the weld metal are seen. These are assumed to be ZrN. The lack of AlN precipitations and the great amount of ZrN are assumed to depend on the high content of Zr in Filler 4.

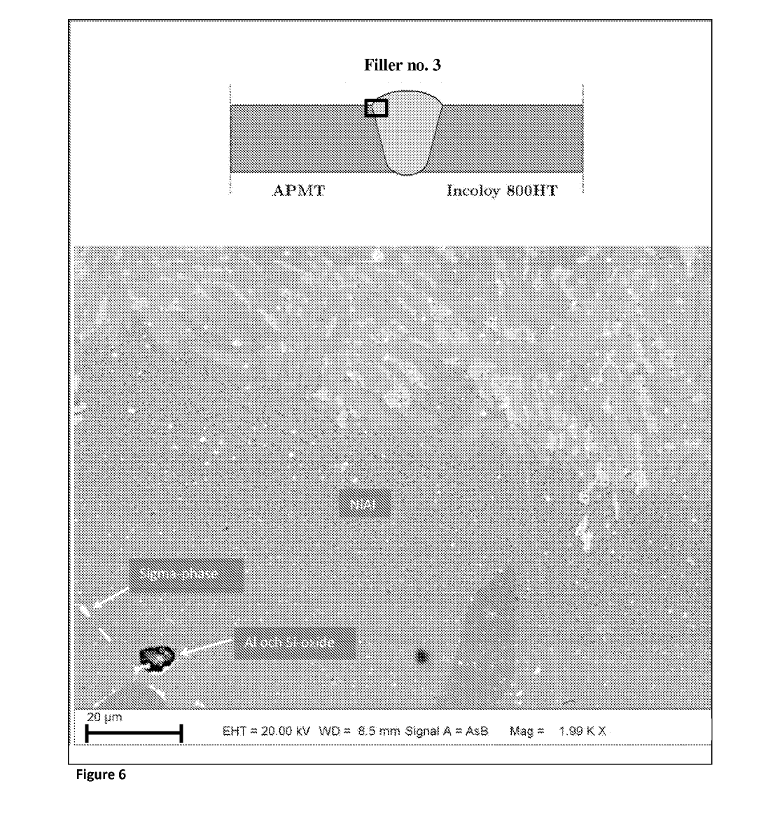

FIG. 6 shows a SEM image from a sample from a welded joint between Incoloy 800HT-Filler No. 3-APMT, which has been heat treated for 500 h at 750° C. The sample has been taken in the interface of weld metal of Filler 3 and the parent metal APMT. In this sample, precipitations of NiₓAlₓ (nickel aluminide) have been formed in the weld junction between the filler and the parent metal (APMT). The formation of nickel aluminide is assumed to depend on the filler having high content of nickel as well as the parent metal having high content of Al. Furthermore, the content of zirconium is relatively low in Filler 3—0.63% by weight.

To sum up, the SEM images show that Fillers 2 and 4, which have a high content of zirconium, contribute to minimize the formation of aluminium nitride (AlN) in the weld metal. It should also be noted that in the cases austenitic steel with high content of nitrogen is used as parent metal, the Zr content in the filler should be high in order to avoid the formation of AlN, cf. FIGS. 3 and 4.

1. A filler for welding comprising (in % by weight):
C: ≦0.036
Ni: 15.0-20.0
Cr: 15.0-22.0
Mn: 0.75-2.0
Zr: 0.1-1.45
Si: 0-1.5
Al: 0-2
N: <0.06
and a balance of Fe and inevitable impurities.

2. The filler according to claim 1, wherein C is ≦0.030% by weight.

3. The filler according to claim 1, wherein Ni is 15-17% by weight.

4. The filler according to claim 1, wherein Cr is 17-22% by weight.

5. The filler according to claim 1, wherein Mn is 0.75-1.75% by weight.

6. The filler according to claim 1, wherein Zr is 0.35-1.45% by weight.

7. The filler according to claim 1, wherein Zr is 0.1-1.3% by weight.

8. The filler according to claim 1, wherein Si is 0.3-1% by weight.

9. The filler according to claim 1, wherein Al is 0-1% by weight.

10. The filler according to claim 1, wherein N is 0-0.03% by weight.

11. The filler according to claim 1, wherein the filler is in the form of a welding band or a welding wire.

12. The filler according to claim 1, wherein Ni is 17-20% by weight.

13. The filler according to claim 1, wherein Cr is 15-19% by weight.

14. The filler according to claim 1, wherein Zr is 1.15-1.45% by weight.

15. The filler according to claim 1, wherein Zr is 0.35-1.39% by weight.

16. The filler according to claim 1, wherein Zr is 0.5-0.7% by weight.
